(19) United States
(12) Patent Application Publication
(10) Pub. No.: US 2025/0272048 A1
(43) Pub. Date: Aug. 28, 2025

(54) DYNAMIC DIGITAL NUMBER PLATES AND ASSOCIATED SYSTEMS AND METHODS

(71) Applicant: Novacore, Inc., New York, NY (US)

(72) Inventors: Jesse Tayeh, New York, NY (US); Aidar Gadiev, Glendale, CA (US); Tatiana Tayeh, New York, NY (US); Oleg Surkov, Kaliningrad (RU); Anton Aspisov, Antalya (TR)

(21) Appl. No.: 19/058,696

(22) Filed: Feb. 20, 2025

Related U.S. Application Data
(60) Provisional application No. 63/557,368, filed on Feb. 23, 2024.

(51) Int. Cl. G06F 3/147; G09G 3/34; G09G 3/36

(52) U.S. Cl. CPC G06F 3/147; G09G 3/344; G09G 3/36; G09G 2330/02; G09G 2370/022; G09G 2380/10

(57) ABSTRACT

Digital number plate systems that include electronic displays and can integrate with broader vehicle systems, as well as associated methods, apparatuses, and systems, are disclosed herein. The digital number plate system can be comprised of a digital number plate that includes an electronic display that can be controlled by a mobile computing device. To do this the digital number plate includes a main processing unit with a communication module. The main processing unit processes and controls display data received by the electronic display. The communication module facilitates communication with the mobile computing device and with a host server and/or network.

CROSS-REFERENCE TO RELATED APPLICATION(S)

This application claims priority to U.S. Provisional Patent Application No. 63/557,368, filed Feb. 23, 2024, which is incorporated by reference herein in its entirety.

### TECHNICAL FIELD

The present technology is generally directed to external vehicle displays, specifically digital number plates, and associated systems and methods.

### BACKGROUND

A vehicle registration plate (also known as a number plate or license plate) is a device attached to a motor vehicle for official identification purposes. All states in the United States (and, indeed, most countries around the world) require that vehicles display one or more license plates for road vehicles (e.g., cars, commercial trucks, ambulances). Additionally, many jurisdictions require license plates for other types of vehicles (e.g., bicycles, boats, tractors). Originally, license plates provided only required registration information, but most jurisdictions today permit some degree of license plate customization such as personal plate messages (e.g., “vanity” plates) or license plate accessories.

Every jurisdiction has its own regulations regarding the display of registration information and permissible customizable options, and most require frequent updates to the displayed registration information. Thus, challenges arise for vehicle owners to ensure their license plates continuously comply with a given jurisdiction's regulations. Furthermore, the amount of information that can be displayed on a typical license plate is constrained by the physical limitations of the plate (e.g., size, shape). While electronic license plates have been suggested as a solution to some of these issues, challenges continue to persist.

### BRIEF DESCRIPTION OF THE DRAWINGS

Many aspects of the present technology can be better understood with reference to the following drawings. The components in the drawings are not necessarily drawn to scale. Instead, emphasis is placed on clearly illustrating the principles of the present technology. Furthermore, components can be shown as transparent in certain views for clarity of illustration only and not to indicate that the component is necessarily transparent. Components may also be shown schematically.

FIG. 1 is a perspective view of a vehicle with a digital number plate configured in accordance with embodiments of the present technology.

FIGS. 2A-2C are various views of the digital number plate of FIG. 1 before installation with the vehicle.

FIG. 3 is a block diagram illustrating an overview of an example of a device on which one or more embodiments of the present technology can operate.

FIG. 4 is a block diagram illustrating an overview of an environment in which some embodiments of the present technology can operate.

FIG. 5 is a block diagram illustrating components of a computing device configured in accordance with some embodiments of the present technology.

FIG. 6 is a flow diagram of a method of using a digital number plate system configured in accordance with one or more embodiments of the present technology.

### DETAILED DESCRIPTION

### Overview

The present technology is generally directed to dynamic digital number plate systems that can integrate with broader vehicle systems and associated methods and devices. As one example, vehicle systems configured in accordance with the present technology (including digital number plates) consolidate multiple aspects of vehicle administration management into a single digital device, including streamlining the vehicle registration process, and providing toll and parking information. As another example, the disclosed digital number plate systems are expected to provide greatly expanded opportunities for personal customization and commercial advertising capabilities, enhancing both functionality and the driving experience. Thus, individual vehicle owners will have new opportunities for self-expression, and businesses will be able to effectively use their vehicle fleet for advertising without incurring additional costs or using permanent fixtures.

Jurisdictions throughout the world have rules and regulations governing vehicle administration such as, for example, the periodicity of vehicle registration renewal, insurance requirements, registration number displays, registration plate design and customization, payment of tolls on certain roads/bridges/gates, and parking administration and ticketing, etc. Furthermore, such rules and regulations can vary widely from jurisdiction to jurisdiction. This can result in a substantial administrative burden on vehicle owners as they navigate not only the administrative requirements of the jurisdiction in which they live, but also the administrative variability of jurisdictions to which they travel or move. To overcome some of these difficulties, electronic license plates have been suggested. However, challenges persist with many electronic license plates.

To overcome these technical deficiencies, digital number plate systems disclosed herein are configured to integrate with broader vehicle systems and allow for a wide range of dynamic display features. In some embodiments, for example, the disclosed technology provides an electronic display that is communicatively coupled to a main processing unit (also referred to as a “main unit” or “main printed circuit board” (“main PCB”)). The main processing unit is comprised of a memory and processor and is operably coupled with a communication module. The communication module facilitates communication of the main processing unit with a host server or network (e.g., the cloud), and can be communicatively coupled to a mobile computing device and/or remote computing system. Thus, a user can use the mobile computing device and/or remote computing system to control the image of the electronic display on the digital number plate. This is expected to simplify vehicle administration by providing a single device that provides multiple pieces of vehicle information, such as vehicle registration number, registration tabs, toll information, parking ticket, and/or parking pass information, all of which can be easily changed by a vehicle owner via a mobile computing device. In some embodiments, the main processing unit can be configured to integrate multiple vehicle systems together into a single vehicle control system. For example, the main processing unit can facilitate control of the electronic display and can integrate data from one or more vehicle camera devices, a GPS module, and one or more environmental sensors, to name a few.

Furthermore, the disclosed technology is expected to provide expanded opportunities for commercial advertising by providing a platform for advertising that can save on promotional costs. In some embodiments, the disclosed technology provides a platform for individual self-expression through a wide range of customization and personalization capabilities. For example, the electronic digital number display can be controlled to depict a graphic of the vehicle owner's choosing, or provide real-time messages like “Baby on Board,” or “In Emergency.” In some embodiments, emergency vehicles can control the electronic display provide visual emergency signals or provide real-time updates about their status.

For ease of reference, the digital number plate systems disclosed herein are sometimes described with reference to top and bottom, upper and lower, upwards and downwards, and/or horizontal plane, x-y plane, vertical, or z-direction relative to the spatial orientation of the embodiments shown in the figures. It is to be understood, however, that the digital number plate system can be moved to, and used in, different spatial orientations without changing the structure and/or function of the disclosed embodiments of the present technology.

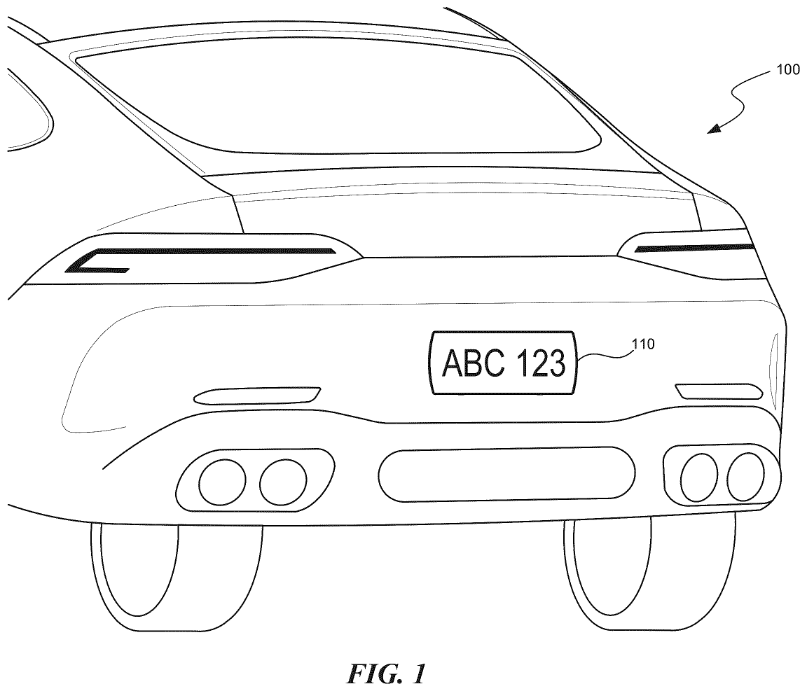

The terminology used in the description presented below is intended to be interpreted in its broadest reasonable manner, even though it is being used in conjunction with a detailed description of certain specific embodiments of the present technology. Certain terms may even be emphasized below; however, any terminology intended to be interpreted in any restricted manner will be overtly and specifically defined as such in this Detailed Description section. Additionally, the present technology can include other embodiments that are within the scope of the examples but are not described in detail with respect to FIGS. 1-6.

Reference throughout this specification to “one embodiment” or “an embodiment” means that a particular feature, structure, or characteristic described in connection with the embodiment is included in at least one embodiment of the present technology. Thus, the appearances of the phrases “in one embodiment” or “in an embodiment” in various places throughout this specification are not necessarily all referring to the same embodiment. Furthermore, the particular features or characteristics may be combined in any suitable manner in one or more embodiments. The headings provided herein are for convenience only and do not interpret the scope or meaning of the claimed present technology.

Reference throughout this specification to relative terms such as, for example, “substantially,” “approximately,” and “about” are used herein to mean the stated value plus or minus 10%.

Further, although primarily discussed herein as systems and methods for improving vehicle administration functions and expanding opportunities for personal customization and commercial advertising, one of skill in the relevant art will understand that the scope of the present technology is not so limited and the present technology can be readily adapted for use with a variety of other vehicle-related or other applications.

### Dynamic Digital Number Plate Systems and Associated Systems and Methods

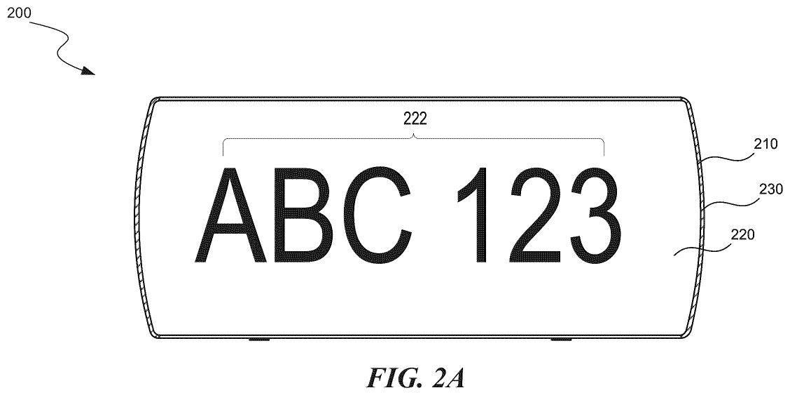

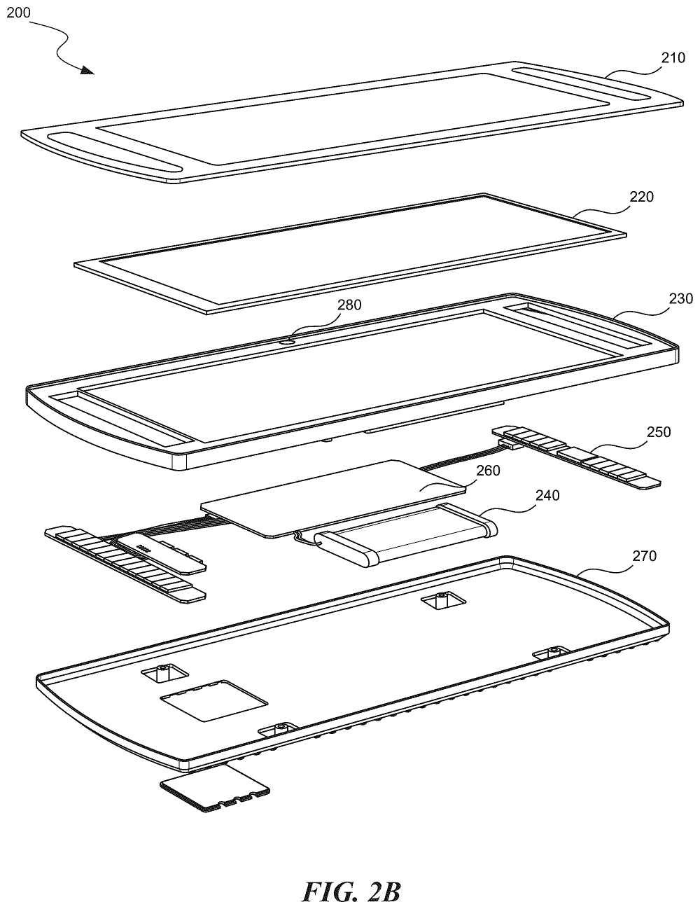

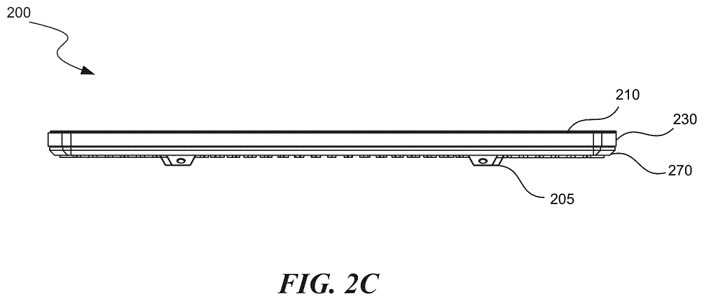

FIG. 1 is a perspective view of a vehicle 100 with a digital number plate 110 configured in accordance with embodiments of the present technology. The vehicle 100 can include a car (as shown in FIG. 1) or any other suitable vehicle on which a license plate is displayed, such as a commercial truck, a van, an ambulance, or the like. Although only a single digital number plate 110 is shown at the rear portion of the vehicle 100 in FIG. 1, it will be appreciated that the vehicle 100 can include one or more digital number plates 110 positioned at rear of the vehicle 100, front of the vehicle 100, or other suitable locations on the vehicle 100. Further details regarding the digital number plate 110 and associated vehicle systems are described below with reference to FIGS. 2A-6.

FIGS. 2A-2C, for example, are various views of a digital number plate 200 before installation with the vehicle. More specifically, FIG. 2A is a front view of the digital number plate 200, FIG. 2B is an exploded view of the digital number plate 200, and FIG. 2C is a bottom edge view of the digital number plate 200. It will be appreciated that the digital number plate 200 may be an example of the digital number plate 110 of FIG. 1, or another digital number plate configured in accordance with the present technology.

Referring first to FIG. 2A, the digital number plate 200 comprises an outer cover 210 and an electronic display 220. The electronic display 220 is configured to display indicia 222 (e.g., letters, symbols, graphics, images, etc., or any combination thereof). The electronic display 220 is positioned in a display enclosure 230. In the present embodiment the digital number plate 200 is approximately the length, height, and shape of a typical state license plate in the United States. It will be appreciated, however, that the present technology is not limited to such specifications and in additional embodiments the digital number plate 110 can have a variety of different desired sizes and shapes appropriate for use as a vehicle license plate in different jurisdictions.

Referring to FIGS. 2A and 2B together, the electronic display 220 is adhered to the outer cover 210 and the outer cover 210 is adhered to the display enclosure 230. In such embodiments, the enclosure of digital number plate 200 nonetheless has a transparent portion through which the electronic display 220 is visible. In some embodiments, for example, the electronic display 220 can be glued to the outer cover 210, and the outer cover 210 can be press fit with the display enclosure 230. In further embodiments, the electronic display 220 is adhered to the display enclosure 230 instead of the outer cover 210. In additional embodiments, the electronic display 220 is adhered to both the outer cover 210 and the display enclosure 230. The outer cover 210 can be composed of any substantially transparent material. In some embodiments, for example, the outer cover 210 is comprised of tempered glass. In some embodiments, the display enclosure 230 is comprised of aluminum. In other embodiments, however, the display enclosure 230 may be composed of other suitable materials. The display enclosure 230 (in conjunction with the outer cover 210 and support plate 270) defines a sealed, waterproof or water-resistant enclosure that mitigates environmental exposure, wear, and/or damage to the electronic display 220 and the other components of the digital number plate 200.

The electronic display 220 is configured to provide reliable, dynamic presentation of display data, such as vehicle registration data, personalized messages, and/or business advertising. Other non-limiting examples of display data can include a quick-response (QR) code, a vehicle identification number (VIN), a picture, a graphic, a symbol, a slogan, a color, a video, or any combination of one or more of these examples. In some embodiments, the electronic display 220 is comprised of a reflective electrophoretic display module based on an active matrix thin-film transistor (TFT) substrate. The electrophoretic display module provides high reflectance, ultra-wide viewing angle, and ultra-low power consumption. Power consumption is low in part because power is usually only consumed by the electronic display 220 when the images on the electronic display 220 are changed. When power is removed from the electronic display 220, the crystals comprising the electronic display retain the state they were in at the time power was removed. In some embodiments, the electronic display 220 further includes an antiglare hard-coated front-surface. In some embodiments, the electronic display 220 includes one or more color elements (not shown) configured to cause the display data to be displayed in color. For example, the electronic display 220 can include one or more liquid crystal display (LCD) elements and/or one or more light-emitting diode (LED) elements.

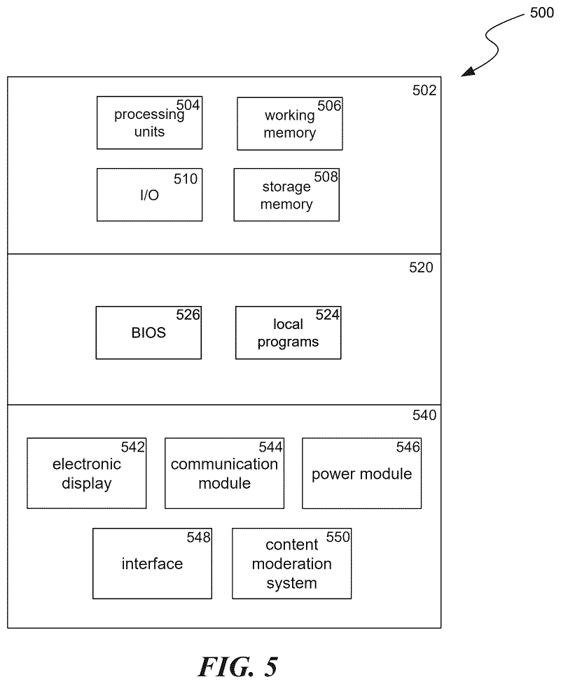

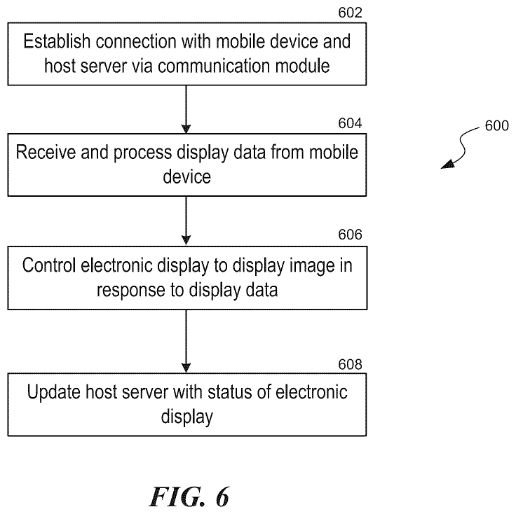

As best seen in FIG. 2B, the digital number plate 200 further comprises a power supply 240, a solar element 250, a main processing unit (also referred to as a “main unit” or “main printed circuit board” (“main PCB”)) 260, a communication module (discussed below in FIGS. 5-6), and a support member or support plate 270. The power supply 240 is configured to provide electrical power to the electronic display 220, the main processing unit 260, and other components of the digital number plate 200. In some embodiments, however, power to the electronic display 220, the main processing unit 260, and/or one or more additional components of the digital number plate is sourced directly from vehicle power. In additional embodiments, power to the components of the digital number plate 200 (including the electronic display 220 and the main processing unit 260) can be sourced from either a power source internal to the digital number plate 200 (e.g., a lithium ion battery), or directly from vehicle power. In some embodiments, the solar element 250 facilitates charging of the power supply 240.

The main processing unit 260 is comprised of a memory and processor and is configured with a communication module. The memory stores instructions that, when executed by the processor, control various components of the digital number plate 200. In some embodiments, for example, the memory stores instructions that, when executed by the processor, control the image displayed on the electronic display 220, and control power management of the power supply 240. In some embodiments, the main processing unit 260 can be configured to integrate multiple vehicle systems together into a single vehicle control system. For example, the memory can store instructions that, when executed by the processor, integrate data from one or more vehicle camera devices (not shown), a GPS module (not shown), and one or more environmental sensors (not shown), to name a few examples. The communication module is further configured to facilitate communication of the main processing unit 260 with a remote host server or network (e.g., the cloud), and can be communicatively coupled to multiple external devices, such as mobile computing devices and/or remote computing systems.

In some embodiments, the digital number plate 200 can include a content moderation system that provides feedback to a vehicle owner regarding content displayed on the electronic display 220 that may not adhere to a given jurisdiction's rules and regulations. In some embodiments, for example, the content moderation system prevents displaying images, graphics, symbols, words, and/or other indicia 222 that may not adhere to a given jurisdiction's rules and regulations. In such embodiments, the main processing unit 260 stores instructions that, when executed, control the content moderation system.

In some embodiments, digital number plate 200 can include a camera 280. In such embodiments, the main processing unit 260 stores instructions that, when executed, control the camera 280. The communication module can facilitate transmission of photographic images and/or video feed from the camera 280 to a user interface (e.g., a mobile computing device).

Turning to FIG. 2C, in some embodiments, digital number plate 200 can include one or more brackets 205 internally formed with the support plate 270 of the digital number plate 200 to facilitate mounting of the digital number plate 200 with a vehicle (as illustrated, for example, in FIG. 1). In some embodiments the one or more brackets 205 are separately affixed to, rather than integral with, the support plate 270.

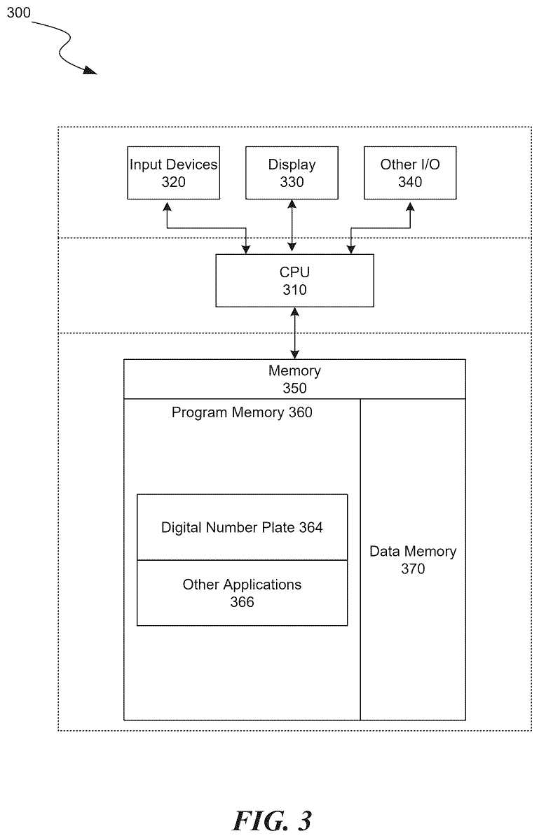

FIG. 3 is a block diagram illustrating an overview of an example of a device on which one or more embodiments of the present technology can operate. In the illustrated embodiment, device 300 includes one or more input devices 320 that provide input to one or more CPU(s) (processor, “the CPU”), 310, notifying it of actions. The actions can be mediated by a hardware controller that interprets the signals received from the input device and communicates the information to the CPU 310 using a communication protocol. Input devices 320 include, for example, a digital number plate (such as the digital number plate 200 described above with reference to FIGS. 2A-2C), a touchscreen, an infrared sensor, a touchpad, a wearable input device, a stereo camera, a multi-scope camera (or other image-based input devices), a microphone, a temperature sensor, an air quality sensor, a motion sensor, a GPS module, or other suitable user input devices.

The CPU 310 can be a single processing unit or multiple processing units in a device or distributed across multiple devices. CPU 310 can be coupled to other hardware devices, for example, with the use of a bus, such as a PCI bus or SCSI bus. The CPU 310 can communicate with a hardware controller for devices, such as for a display 330. The display 330 can be used to display text and graphics. In some embodiments, the display 330 provides graphical and textual feedback to a user. In some embodiments, the display 330 includes the input device as part of the display, such as when the input device is a touchscreen or is equipped with an eye direction monitoring system. In some embodiments, the display is separate from the input device. Examples of display devices are discussed in more detail below but can generally include: rotating LCDs; rotating LEDs; rotating OLEDs; rotating AMOLEDs; rotating semitransparent screens and associated projectors, lasers, and/or LEDs; digital micromirror devices; photophoretic optical trapping display; goniometers and/or MEMS mirrors; and the like. Other I/O devices 340 can also be coupled to the processor, such as a SPI flash memory device, network card, video card, audio card, USB, firewire or other external device, infrared (or near infrared device) device, speakers, and the like.

In some embodiments, the device 300 also includes a communication device capable of communicating wirelessly or wire-based with a network node. The communication device can communicate with another device or a server through a network using, for example, TCP/IP protocols, a Q-LAN protocol, a Narrow Band Internet of Things (NBIoT) protocol, or others. In some embodiments the communication device can communicate using a Bluetooth Low Energy (BLE) protocol. Device 300 can utilize the communication device to distribute operations across multiple network devices.

The CPU 310 can have access to a memory 350 in a device or distributed across multiple devices. A memory includes one or more of various hardware devices for volatile and non-volatile storage and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 350 can include program memory 360 that stores programs and software, such as a digital number plate component 364, and other application programs 366. Memory 350 can also include data memory 370 that can include data to be operated on by applications, configuration data, settings, options or preferences, etc., which can be provided to the program memory 360 or any element of the device 300.

Some embodiments can be operational with numerous other computing system environments or configurations. Examples of computing systems, environments, and/or configurations that may be suitable for use with the technology include, but are not limited to, personal computers, AVC I/O systems, networked AVC peripherals, video conference consoles, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

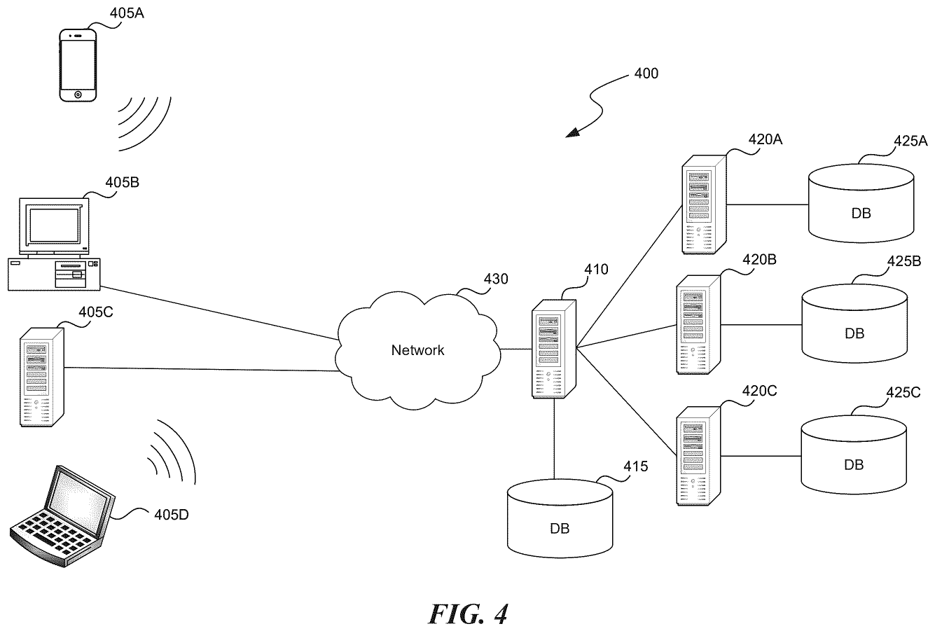

FIG. 4 is a block diagram illustrating an overview of an environment in which some embodiments of the present technology can operate. Environment 400 can include one or more client computing devices 405A-D, examples of which can include device 300. In the illustrated embodiment, device 405A is a wireless smartphone or tablet, device 405B is a desktop computer, device 405C is a computer system, and device 405D is a wireless laptop. These are only examples of some of the devices, and other embodiments can include other computing devices. For example, device 405C can be a server with an OS implementing display and power management software for a digital number plate. The server can have sufficient computational resources to process data, as needed, in real time to help facilitate the display and power management software and/or minimize the computational resources needed by the digital number plate. Additionally, the client computing devices 405 can operate in a networked environment using logical connections through network 430 to one or more remote computers, such as a server computing device 410 to provide these services.

In some embodiments, the server computing device 410 is an edge server which receives client requests and coordinates the fulfillment of those requests through other servers, such as servers 420A-C. Server computing devices 410 and 420 can comprise computing systems, such as device 300. Though each server computing device 410 and 420 is displayed logically as a single server, server computing devices can each be a distributed computing environment encompassing multiple computing devices located at the same or at geographically disparate physical locations. In some embodiments, each server 420 corresponds to a group of servers.

Client computing devices 405 and server computing devices 410 and 420 can each act as a server or client to other server/client devices. Server 410 can connect to a database 415. Servers 420A-C can each connect to a corresponding database 425A-C. As discussed above, each server 420 can correspond to a group of servers, and each of these servers can share a database or can have their own database. Databases 415 and 425 can warehouse (e.g., store) information. Though databases 415 and 425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN) but can also be other wired or wireless networks. In some embodiments, portions of network 430 can be a LAN or WAN implementing a relevant communication protocol. Portions of network 430 may be the Internet or some other public or private network. Client computing devices 405 can be connected to network 430 through a network interface, such as by wired or wireless communication. In some embodiments, client computing devices 405 can connect to network 430 using a NBIoT protocol. While the connections between server 410 and servers 420 are shown as separate connections, these connections can be any kind of local, wide area, wired, or wireless network, including network 430 or a separate public or private network.

FIG. 5 is a block diagram illustrating components of a computing device configured in accordance with some embodiments of the present technology. The components 500 include hardware 502, general software 520, and specialized components 540. As discussed above, a system implementing the disclosed technology can use various hardware including processing units 504 (e.g., CPUs, GPUs, APUs, etc.), working memory 506, storage memory 508 (local storage or as an interface to remote storage, such as storage 415 or 425), and input and output (I/O) devices 510. In various embodiments, storage memory 508 can be one or more of: local devices, interfaces to remote storage devices, or combinations thereof. For example, storage memory 508 can be a set of one or more hard drives (e.g., a redundant array of independent disks (RAID)) accessible through a system bus or can be a cloud storage provider or other network storage accessible via one or more communications networks (e.g., a network accessible storage (NAS) device, such as storage 415 or storage provided through another server 420). Components 500 can be implemented in a client computing device such as client computing devices 405 or on a server computing device, such as server computing device 410 or 420.

General software 520 can include various applications including local programs 524 and a basic input output system (BIOS) 526. In some embodiments, specialized components 540 can be subcomponents of one or more of the general software applications 520, such as the local programs 524. Specialized components 540 can include an electronic display 542, communication module 544, a power module 546, components which can be used for providing user interfaces, transferring data, and controlling the specialized components, such as interface 548, and a content moderation system 550. In some embodiments, components 500 can be in a computing system that is distributed across multiple computing devices or can be an interface to a server-based application executing one or more of specialized components 540.

In some embodiments, communication module 544 is configured to facilitate communication with multiple devices using multiple different protocols. For example, communication module 544 can be configured to communicate with vehicle systems or subsystems via a CAN link or other wired connection, while also maintaining a wireless connection, such as Wi-Fi, to a user's mobile computing device. In some embodiments, the communication module 544 is configured to utilize a Narrowband Internet of Things (NBIoT) protocol to communicate with devices. In some embodiments the communication module 544 is configured to utilize a machine to machine protocol such as Bluetooth or Bluetooth Low Energy (BLE). Other non-limiting examples of protocols the communication module 544 can be configured to include are: LPWAN/LoRa, IEEE 802.11, 802.15, 802.16 Wi-Fi standards, cellular protocols, and satellite communication protocols.

In some embodiments, the local programs 524 can include a content moderation system 550 that provides feedback to a vehicle owner regarding content displayed on the electronic display (e.g., the electronic display 220 discussed above with reference to FIGS. 2A-C) that may not adhere to a given jurisdiction's rules and regulations. In some embodiments, the content moderation system prevents displaying images, graphics, symbols, words, and/or other indicia that may not adhere to a given jurisdiction's rules and regulations.

Those skilled in the art will appreciate that the components illustrated in FIGS. 3-5 described above may be altered in a variety of ways. For example, the order of the logic may be rearranged, substeps may be performed in parallel, illustrated logic may be omitted, other logic may be included, etc. In some embodiments, one or more of the components described above can execute one or more of the processes described below.

FIG. 6 is a flow diagram of a method 600 of operating a digital number plate system in accordance with one or more embodiments. The method 600 begins at block 602, wherein a digital number plate establishes a connection with a mobile computing device and/or a remote computing system, and a host server via a communication module. In some embodiments the digital number plate includes any of the embodiments discussed above in FIGS. 1-2C. In some embodiments, the digital number plate establishes a connection with any of the client computing devices 405 discussed above in FIG. 4. For example, the digital number plate can also establish a connection with a desktop computer or other computer system. In some embodiments, the digital number plate further establishes a connection with a network, such as the network 430 discussed in FIG. 4. In some embodiments the communication module includes any of the embodiments discussed above in FIGS. 2A-5. For example, the communication module can be configured to connect using a wireless protocol (e.g., 802.11/Wi-Fi), and/or a machine to machine protocol (e.g., Bluetooth protocols). In some embodiments the communication module connects through a NBIoT protocol.

At block 604, display data is received by the digital number plate from the mobile computing device and/or remote computing system. The main processing unit processes the display data in preparation of controlling the electronic display to display the display data. In some embodiments, a content moderation system processes the display data and provides feedback to the mobile computing device and/or remote computing system regarding content displayed on the electronic display that may not adhere to a given jurisdiction's rules and regulations. In some embodiments, the content moderation system prevents displaying images, graphics, symbols, and/or words that may not adhere to a given jurisdiction's rules and regulations.

At block 606 of the method 600, the main processing unit controls the electronic display to display an image associated with the display data. Non-limiting examples of images that the electronic display can be controlled to provide include: a registration plate number, a registration tab, words of the vehicle owner's choosing, a quick-response (QR) code, a vehicle identification number (VIN), a picture, a graphic, a symbol, a slogan, a color, a video, an advertisement, or any combination of these examples. In some embodiments, the electronic display is configured to display the image(s) in color. For example, the electronic display can include one or more LCD and/or LED elements that colorize the image as the image is being displayed.

At block 608 the main processing unit communicates the status of the electronic display to the host server via the communication module. The host server stores this information for later retrieval.

### Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

Claims I/we claim:

1. A digital number plate, comprising:
a support member comprising one or more brackets positioned to be releasably secured to a vehicle;
a display enclosure carried by the support member;
an electronic display carried by the display enclosure; and
an outer cover operably coupled to the display enclosure to define a sealed enclosure surrounding the electronic display, and wherein the outer cover further comprises a transparent portion at least partially aligned with the electronic display,
wherein, during operation, the electronic display is configured to display vehicle registration data and/or other indicia associated with the vehicle.

2. The digital number plate of claim 1 wherein the electronic display comprises a reflective electrophoretic display module based on an active matrix thin-film transistor (TFT) substrate.

3. The digital number plate of claim 1 wherein the electronic display further includes an antiglare hard-coated display surface.

4. The digital number plate of claim 1 wherein the sealed enclosure defined by the outer cover and the display enclosure comprises a water-resistant enclosure surrounding the electronic display.

5. The digital number plate of claim 1 wherein the sealed enclosure defined by the outer cover and the display enclosure comprises a waterproof enclosure surrounding the electronic display.

6. The digital number plate of claim 1, further comprising a camera.

7. The digital number plate of claim 1, further comprising a power source carried by the support member, and wherein the electronic display is operably coupled with and powered via the power source.

8. The digital number plate of claim 7, further comprising a solar element, wherein the solar element is operably coupled with and configured to recharge the power source.

9. The digital number plate of claim 1 wherein the electronic display is operably coupled with and powered via vehicle power.

10. The digital number plate of claim 1 wherein the electronic display includes one or more color elements configured to cause the vehicle registration data and/or other indicia associated with the vehicle to be displayed in color.

11. The digital number plate of claim 10 wherein the color elements include one or more liquid crystal display (LCD) elements.

12. A digital number plate system, comprising:
a digital number plate including:
a memory and processor;
an electronic display;
a communication module configured with wireless and machine to machine protocols; and
a power supply;
wherein the memory stores instructions that, when executed by the processor, control the digital number plate to:
establish a connection with a mobile computing device and a remote host server via the communication module;
receive display data from the mobile computing device and/or the remote host server;
control the electronic display to display an image in response to the display data; and
update the host server with a status of the electronic display.

13. The digital number plate system of claim 12 wherein the communication module is further configured to operate via a Narrow Band Internet of Things (NBIoT) protocol.

14. The digital number plate system of claim 12 wherein the communication module is further configured to operate via a Bluetooth Low Energy (BLE) protocol.

15. The digital number plate system of claim 12, further comprising a camera.

16. The digital number plate system of claim 12 wherein the power supply is powered via vehicle power.

17. The digital number plate system of claim 12 wherein the digital number plate further includes a content moderation system.

18. The digital number plate system of claim 12 wherein the electronic display includes one or more color elements configured to cause the image to be displayed in color.
